(19) United States
(12) Patent Application Publication
(10) Pub. No.: US 2014/0120315 A1
(43) Pub. Date: May 1, 2014

(54) FLEXIBLE MULTILAYER HERMETIC LAMINATE

(71) Applicants: Bruce Gardiner Aitken, Corning, NY (US); Chong Pyung An, Painted Post, NY (US); Shari Elizabeth Koval, Beaver Dams, NY (US); Mark Alejandro Quesada, Horseheads, NY (US)

(72) Inventors: Bruce Gardiner Aitken, Corning, NY (US); Chong Pyung An, Painted Post, NY (US); Shari Elizabeth Koval, Beaver Dams, NY (US); Mark Alejandro Quesada, Horseheads, NY (US)

(21) Appl. No.: 13/660,717

(22) Filed: Oct. 25, 2012

(51) Int. Cl. B32B 17/10; B32B 27/34; B05D 1/36; B32B 27/32; B32B 33/00; B32B 17/06; B32B 27/06

(52) U.S. Cl. 428/142; 428/426; 428/335; 428/412; 428/441; 428/419; 428/432; 427/419.1; 427/402

(57) ABSTRACT

A multi-layer thin film laminate comprises a dyad layer including a barrier layer and a decoupling layer formed over a substrate. The barrier layer comprises a hermetic glass material selected from the group consisting of tin fluorophosphate glasses, tungsten-doped tin fluorophosphate glasses, chalcogenide glasses, tellurite glasses, borate glasses and phosphate glasses and the decoupling layer comprises a polymer material.

### BACKGROUND

The present disclosure relates generally to hermetic barrier layers, and more particularly to methods and compositions used to seal solid structures using low melting temperature (LMT) glasses that are incorporated into a flexible, hermetic laminate.

Recent research has shown that single-layer thin film inorganic oxides, at or near room temperature, typically contain nanoscale porosity, pinholes and/or other defects that preclude or challenge their successful use as hermetic barrier layers. In order to address the apparent deficiencies associated with single-layer films, multi-layer encapsulation schemes have been developed. The use of multiple layers can minimize or alleviate defect-enabled diffusion and substantially inhibit ambient moisture and oxygen permeation.

Although multiple-layer or even single-layer encapsulation techniques may be optimized, such blanket encapsulation approaches are generally confined to implementation within dedicated in-line vacuum systems. Because conventional single and multiple-layer approaches involve complex processing and typically elevated cost, simple, economical hermetic layers and methods for forming them are highly desirable. For instance, it would be desirable to develop hermetic materials and attendant processes for the creation of hermetic encapsulation under atmospheric conditions.

In a related approach, glass-to-glass bonding techniques can be used to sandwich a workpiece between adjacent substrates and generally provide a degree of encapsulation. Conventionally, glass-to-glass substrate bonds such as plate-to-plate sealing techniques are performed with organic glues or inorganic glass frits. Device makers of systems requiring thoroughly hermetic conditions for long-term operation generally prefer inorganic metal, solder, or frit-based sealing materials because organic glues (polymeric or otherwise) form barriers that are generally permeable to water and oxygen at levels many orders of magnitude greater than the inorganic alternatives. On the other hand, while inorganic metal, solder, or frit-based sealants can be used to form impermeable seals, the resulting sealing interface is generally opaque as a result of the metal cation composition, scattering from gas bubble formation, and distributed ceramic-phase constituents.

Frit-based sealants, for instance, include glass materials that have been ground to a particle size ranging typically from about 2 to 150 microns. For frit-sealing applications, the glass frit material is mixed with a negative CTE material having a similar particle size, and the resulting mixture is blended into a paste using an organic solvent. Example negative CTE inorganic fillers include cordierite particles (e.g. Mg₂Al₃ [AlSi₅O₁₈]) or barium silicates. The solvent is used to adjust the viscosity of the mixture.

Further, the negative CTE inorganic fillers, which are used in order to lower the thermal expansion coefficient mismatch between typical substrates and the glass frit, will be incorporated into the bonding joint and result in a frit-based barrier layer that is neither transparent nor translucent. In contrast to the methods of the present disclosure, realization of the frit seal is accomplished at relatively high temperature and pressure.

Based on the foregoing, it would be desirable to develop hermetic sealing solutions at low temperatures where the sealing materials are both hermetic and optically transparent.

### SUMMARY

Disclosed herein are materials and systems that can be used to form transparent and/or translucent barrier layers. The barrier layers include multiple layers that create a tortuous diffusion path for diffusing species. The multilayer barriers are thin, impermeable and mechanically robust. The disclosed multi-layer approaches involve alternating inorganic and polymer layers, where an inorganic layer can be formed both immediately adjacent the substrate or workpiece to be protected and as the terminal or topmost layer in the multi-layer stack.

The multilayer structure is formed over a substrate and can prevent the ingress of gaseous or liquid species to (or egress from) the substrate. The multilayer structure includes one or more repeat units, also referred to herein as dyad layers, where each dyad layer comprises a barrier layer and a decoupling layer. The barrier layer is formed from an inorganic, glass material such as a tin fluorophosphate glass, tungsten-doped tin fluorophosphate glass, chalcogenide glass, tellurite glass, borate glasses, phosphate glasses or combinations thereof. The decoupling layer may include an organic material such as a polymeric material. The substrate on which the dyad layers are formed may be a passive substrate or may include an active device.

A tortuous path diffusion geometry is created from the disparate characteristics of the alternating barrier (inorganic) and decoupling (organic) layers. Such characteristics may include the respective thickness, composition, defect size, defect distribution, etc. in each of the layers. Thus, a permeating material must transition, or decouple, from one diffusion-path environment in the barrier layer, for example, to a different diffusion-path environment in the decoupling layer of each dyad. A tortuous diffusion path can be created by assembling a plurality of adjacent dyad layers.

The disclosed structures and methods are economically attractive because one can produce large footprint hermetic barrier film off-line, independent of sensitive device fabrication and encapsulation efforts. Such barrier film maybe introduced into non-vacuum device fabrication environments for sealing the workpiece, with the economic benefits arising from reduction in energy, water, capital investment and maintenance costs associated with vacuum deposition inline systems versus laser sealing film-to-film in an inert environment. The higher manufacturing efficiency can be achieved with such a scenario because the encapsulation rate is determined by thermal activation and bond formation, rather than the deposition rate of the glass layer within a deposition chamber or inert gas assembly line.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a schematic of a multi-layer thin film laminate having a single dyad layer according to one embodiment;

FIG. 2 is a schematic of a multi-layer thin film laminate according to an embodiment;

FIG. 3 is a schematic of a multi-layer thin film laminate having a pair of dyad layers according to one embodiment;

FIG. 4 is a schematic of a multi-layer thin film laminate according to a still further embodiment;

FIG. 5 is a schematic of a multi-layer thin film laminate having a single dyad layer according to one embodiment;

FIG. 6 is a schematic diagram of a single chamber sputter tool for forming hermetic inorganic layers;

FIG. 7 illustrates an example manufacturing method for forming a multi-layer thin film laminate; and

FIG. 8 is a plot showing calcium test patch degradation as a function of time under accelerated test conditions.

### DETAILED DESCRIPTION

A substrate is protected by a multi-layer thin film laminate that comprises one or more dyad layers formed over the substrate. Each dyad layer includes a barrier layer and a decoupling layer. In embodiments, the barrier layer is an inorganic layer and the decoupling layer is an organic layer. The barrier layer may comprise a glass material selected from the group consisting of tin fluorophosphate glasses, tungsten-doped tin fluorophosphate glasses, chalcogenide glasses, tellurite glasses, borate glasses and phosphate glasses. The decoupling layer may include various polymer materials such as poly-methyl-methacrylate (PMMA).

The multi-layer laminate may include alternating inorganic and organic layers that are formed over a flexible planarized substrate. An example flexible substrate material is polyethylene terephalate (PET) optionally planarized with a thin PMMA film. In embodiments, the layer immediately adjacent to the substrate and the outermost layer are each inorganic layers. Each layer in the multilayer laminate may be formed sequentially or, in an alternate embodiment, a plurality of dyad pairs may be formed separately and then assembled to form the laminate. During formation of the laminate, the surface of each deposited inorganic layer may be plasma-treated prior to forming or depositing an adjacent polymer layer. The polymer layers are generally not plasma-treated.

The total number of layers (barrier layers and decoupling layers) may be selected depending on the application and the desired degree of protection. In embodiments, from 1 to 6 dyad layers (e.g., 1, 2, 3, 4, 5 or 6 dyad layers) may be provided over the substrate. The multi-layer thin film laminate is lightweight, and usually has a good flexibility and resiliency, as well as resistance to cracking and delaminating.

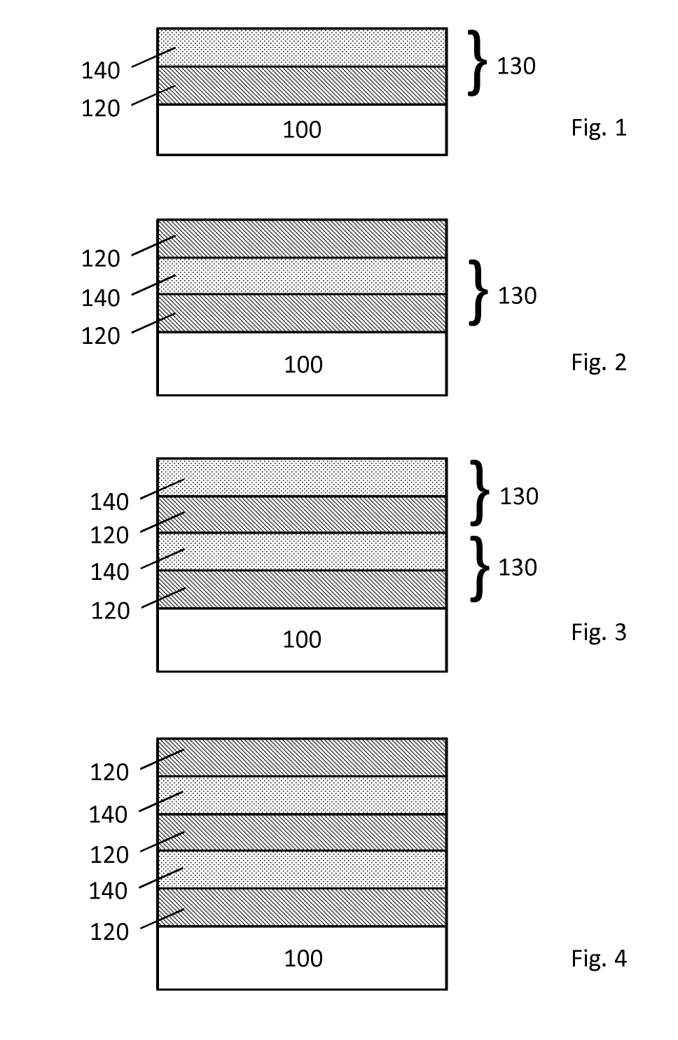

A simplified multi-layer thin film laminate is illustrated in FIG. 1. The laminate includes an inorganic layer 120 formed over a substrate 100, and a decoupling layer 140 formed over the inorganic layer. The inorganic layer 120 and the decoupling layer 140 together define a single dyad layer 130.

A variant of the FIG. 1 laminate structure is shown in FIG. 2. The multi-layer thin film laminate of FIG. 2 includes a dyad layer 130 formed over substrate 100 and a further inorganic layer 120 formed over the dyad layer such that the inner-most (adjacent to the substrate) and outer-most layers of the laminate are inorganic layers.

Example multi-layer thin film laminates having a plurality of dyad layers are shown in FIGS. 3 and 4. In FIG. 3, two successive dyad layers 130 are formed over substrate 100 where the dyad layers are configured such that a barrier layer 120 is in physical contact with the substrate 100. In FIG. 4, which includes an outermost barrier layer, a barrier layer 120 is in physical contact with the substrate and each decoupling layer 140 is in physical contact with a pair of opposing barrier layers.

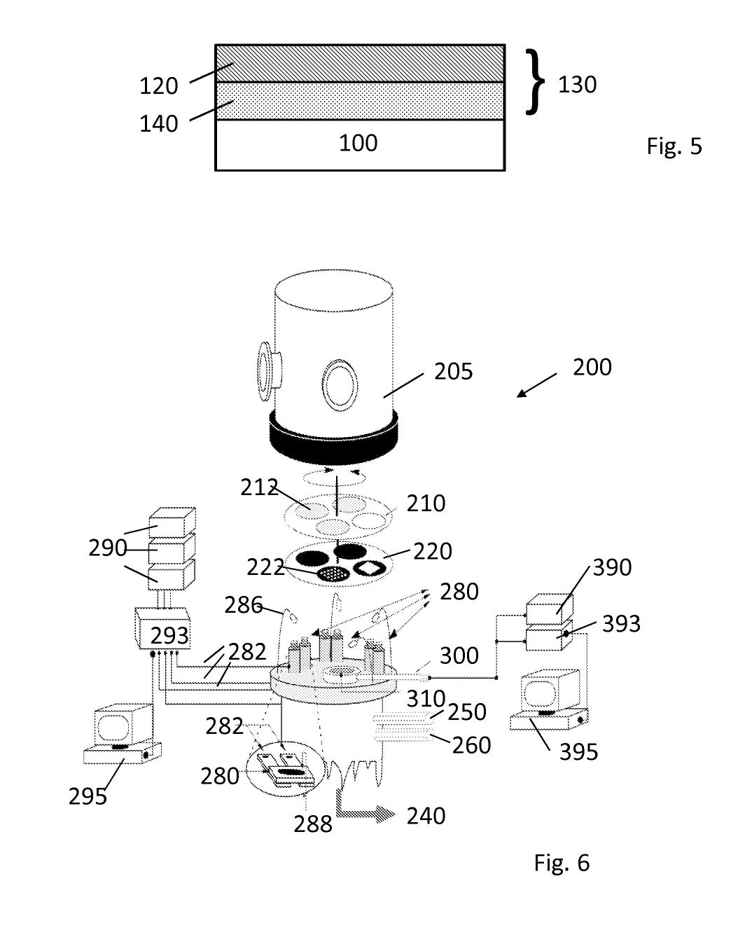

A multi-layer thin film laminate having an alternate configuration is shown in FIG. 5. In the FIG. 5 embodiment, a dyad layer 130 comprising an inorganic layer 120 and a decoupling layer 140 is formed over substrate 100. As illustrated, the dyad layer is arranged such that the decoupling layer 140 is in physical contact with the substrate 100. As will be appreciated, such a configuration can form the basis of a multi-layer thin film laminate having plural dyad layers.

In various embodiments, the dyad layers (including any un-paired inorganic layer or decoupling layer) are transparent and/or translucent, thin, impermeable, “green,” and configured to form hermetic seals. In embodiments, the inorganic layer(s) and decoupling layer(s) are free of fillers and/or binders. Further, the inorganic materials used to form the inorganic layer(s) are not frit-based or powders formed from ground glasses.

In a multi-layer thin film laminate comprising a plurality of dyad layers, characteristics of the individual barrier layers and decoupling layers may be the same or different. Example layer characteristics that can vary or be held constant across plural dyad layers include composition and thickness.

In embodiments, a low melting temperature glass can be used to form the inorganic layers. As used herein, a low melting temperature glass has a softening point less than 500° C., e.g., less than 500, 400, 350, 300, 250 or 200° C. In embodiments where the barrier layer comprises a glass material, such glass can have a glass transition temperature of less than 400° C. (e.g., less than 400, 350, 300, 250, or 200° C.).

Exemplary materials that can form the barrier (inorganic) layer can include copper oxides, tin oxides, silicon oxides, tin phosphates, tin fluorophosphates, chalcogenide glasses, tellurite glasses, borate glasses, and combinations thereof.

Example compositions of suitable tin fluorophosphate glasses, for example, include: 20-75 wt. % tin, 2-20 wt. % phosphorus, 10-46 wt. % oxygen, 10-36 wt. % fluorine, and 0-5 wt. % niobium. An example tin fluorophosphate glass includes: 22.42 wt. % Sn, 11.48 wt. % P, 42.41 wt. % O, 22.64 wt. % F and 1.05 wt. % Nb. Example tungsten-doped tin fluorophosphate glasses include: 55-75 wt. % tin, 4-14 wt. % phosphorus, 6-24 wt. % oxygen, 4-22 wt. % fluorine, and 0.15-15 wt. % tungsten. Further example inorganic layer compositions, expressed in terms of mole percent of the constituent oxides, include 20-100% SnO, 0-50% SnF₂, 0-30% P₂O₅ and as optional additions 0-10% WO₃ or 0-5% Nb₂O₅. Still further example inorganic layer compositions include 20-100% SnO, 0-50% SnF₂, 0-30% B₂O₃ and as optional additions 0-10% WO₃ or 0-5% Nb₂O₅.

Additional aspects of suitable low melting temperature glass compositions and methods used to form glass layers from these materials are disclosed in commonly-assigned U.S. Pat. Nos. 8,115,326, 5,089,446, 7,615,506, 7,722,929, 7,829,147 and commonly-assigned U.S. Patent Application Publication Nos. 2007/0040501 and 2012/0028011 the entire contents of which are incorporated by reference herein.

The inorganic material may be deposited onto a workpiece by, for example, sputtering, co-evaporation, laser ablation, flash evaporation, spraying, pouring, vapor-deposition, dip-coating, painting or rolling, spin-coating, or any combination thereof. A suitable workpiece can include a decoupling layer or other substrate.

A single-chamber sputter deposition apparatus 200 for forming the inorganic layers is illustrated schematically in FIG. 6. The apparatus 200 includes a vacuum chamber 205 having a workpiece stage 210 onto which one or more workpieces 212 can be mounted, and an optional mask stage 220, which can be used to mount shadow masks 222 for patterned deposition of different layers onto the workpiece.

The chamber 205 is equipped with a vacuum port 240 for controlling the interior pressure, as well as a water cooling port 250 and a gas inlet port 260. The vacuum chamber can be cryo-pumped (CTI-8200/Helix; MA, USA) and is capable of operating at pressures suitable for both evaporation processes (˜10⁻⁶ Torr) and RF sputter deposition processes (˜10⁻³ Torr).

As shown in FIG. 6, multiple evaporation fixtures 280, each having an optional corresponding shadow mask 222 for evaporating material onto a workpiece 212 are connected via conductive leads 282 to a respective power supply 290. A starting material 288 to be evaporated can be placed into each fixture 280. Thickness monitors 286 can be integrated into a feedback control loop including a controller 293 and a control station 295 in order to affect control of the amount of material deposited.

In an example system, each of the evaporation fixtures 280 are outfitted with a pair of copper leads 282 to provide DC current at an operational power of about 80-180 Watts. The effective fixture resistance will generally be a function of its geometry, which will determine the precise current and wattage.

An RF sputter gun 300 having a sputter target 310 is also provided for forming an inorganic layer on a workpiece. The RF sputter gun 300 is connected to a control station 395 via an RF power supply 390 and feedback controller 393. For sputtering glass material, a water-cooled cylindrical RF sputtering gun (Onyx-3™, Angstrom Sciences, PA) can be positioned within the chamber 205. Suitable RF deposition conditions include 50-150 W forward power (<1 W reflected power), which corresponds to a typical deposition rate of about ˜5 Å/second (Advanced Energy, Co, USA). In embodiments, a thickness (i.e., as-deposited thickness) of the inorganic layer can range from about 10 nm to 50 microns (e.g., about 0.01, 0.02, 0.05, 0.1, 0.2, 0.5, 1, 2, 3, 5, 10, 20 or 50 microns).

The inorganic layer can be formed via room temperature sputtering of one or more suitable low melting temperature (LMT) glass materials or precursors for these materials, though other thin film deposition techniques can be used. In order to accommodate various laminate architectures, the shadow masks 222 can be used to produce a suitably patterned barrier layer in situ.

According to embodiments, the choice of the individual dyad layers and the processing conditions for incorporating the dyad layers into the laminate structure and over the substrate are sufficiently flexible that neither the substrate nor any device incorporated therein are adversely affected by formation of the laminate.

Defects such as pinholes in the inorganic layer can be eliminated though a consolidation step (for example, exposure to moisture treatment), to produce a pore-free, gas and moisture impenetrable protective layer. An optional heat treatment step may be performed in a vacuum, or in an inert atmosphere, or under ambient conditions depending upon factors such as the composition of the inorganic material.

In embodiments, the decoupling layer can be a polymer layer. Suitable polymers for the decoupling layer include transparent thermoplastics such as poly(methyl methacrylate) (PMMA), polyethylene naphthalate (PEN), polyethersulfone (PES), polycarbonate (PC), polyethylene terephthalate (PET), polypropylene (PP), oriented polypropylene (OPP), and the like. In embodiments, a thickness of the decoupling layer can range from about 200 nm to 50 microns (e.g., about 0.2, 0.5, 1, 2, 3, 5, 10, 20 or 50 microns).

The substrate on which the dyad layer(s) are formed can be a glass, polymer or metal substrate. The substrate may be a passive substrate or may include an active device. It is within the scope of the present disclosure that the multi-layer thin film laminate may comprise a flexible substrate such as a substrate that may be used to form a flexible display or in the field of flexible electronics. A flexible glass substrate, for example, can have a thickness of from 50 to 500 microns (e.g., 50, 100, 200 or 500 microns) and a bend radius of from 1 to 30 cm (e.g., 1, 2, 5, 10, 20 or 30 cm). The bend radius of an example substrate (e.g., a flexible glass substrate) can be less than 30, 20, 10, 5, 2 or 1 cm, for example.

For certain applications, properties of the multi-layer thin film laminate can include dimensional stability, surface roughness, matched CTE among the constituent layers, toughness, transparency, thermal capability, and barrier properties and/or hermeticity suitable, for instance, for active matrix display fabrication. Example substrate materials may include metals (e.g., stainless steel), thermoplastics (e.g., polyethylene naphthalate (PEN), polyethersulfone (PES), polycarbonate (PC), polyethylene terephthalate (PET), polypropylene (PP), oriented polypropylene (OPP), etc.), glasses (e.g., borosilicates) and semiconductors (e.g., gallium nitride).

Some examples of different devices that can be protected by a multi-layer thin film laminate include a light-emitting device (e.g., OLED device), display device (e.g., LCD displays), a photovoltaic device, a thin-film sensor, an evanescent waveguide sensor, a food container and a medicine container. For instance, the substrate may comprise a glass plate infiltrated with phosphor. The major surface of the substrate can be unroughened, which may be characterized by an arithmetic surface roughness, Ra, of less than 100 nm, e.g., less than 100, 50, 20 or 10 nm.

The formation of the inorganic layer(s) and the decoupling layer(s) as well as any optional heat treatment step can be performed at a relatively low temperature (e.g., less than 500° C. or less than 300° C.) in a vacuum or inert atmosphere. This is done to ensure that a water-free and/or oxygen-free condition is maintained throughout the encapsulation process. This can be especially important for robust, long-life operation of sensitive device components such as organic electronics with minimal degradation.

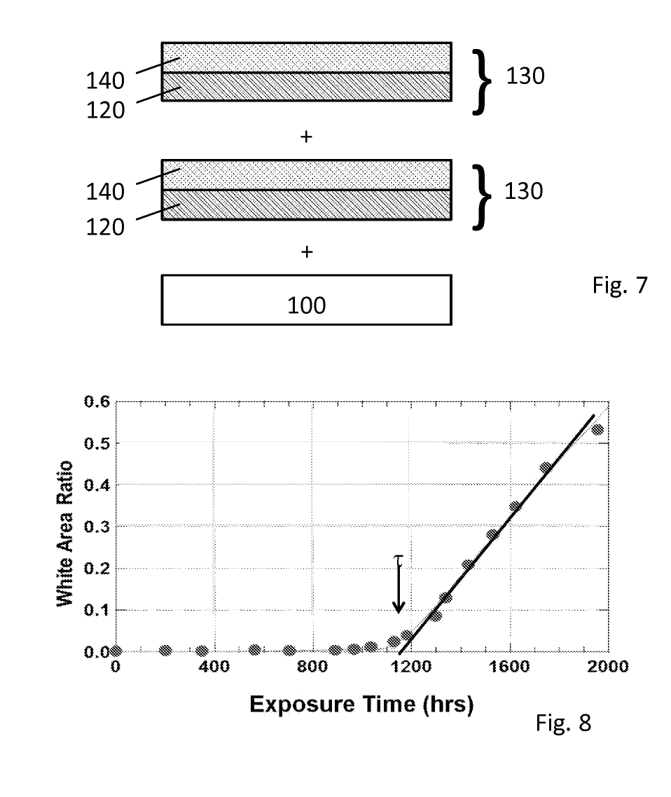

As will be appreciated, a multi-layer thin film laminate can be produced by successively forming inorganic and decoupling layers over a substrate. In an alternate embodiment as illustrated schematically in FIG. 7, a multi-layer thin film laminate can be produced by separately forming each dyad layer 130, for example, by depositing an inorganic layer 140 on a corresponding decoupling layer 120, and then layering one or more such dyad layers over a substrate 100.

The overall all mass flux (g/m²/day) of water, for example, through a dyad multi-layer can be described by the following equation (1):

$${Flux}_{steady \text{-} state} = \frac{{P}_{{H}_{2} O}}{\frac{{l}_{1}}{{D}_{1} {S}_{1}} + \frac{{l}_{2}}{{D}_{2} {S}_{2}} + \frac{{l}_{3}}{{D}_{3} {S}_{3}} + … + \frac{{l}_{n}}{{D}_{n} {S}_{n}}}$$

where subscripts 1, 2, . . . , n denote the successive layers, with 1 corresponding to the upstream inlet side and n the downstream outlet side. The water vapor pressure is denoted P_{H2O}.

The thickness, diffusion coefficient and solubility coefficient of each layer are denoted by symbols l, D, and S respectively.

In order to more readily evaluate the impact of the dyad layer material on the overall hermeticity of the multilayer laminate, equation (1) can be rewritten to represent a multilayer film comprising a plurality of concatenated dyads, with each dyad including an organic, decoupling layer in addition to the inorganic layer. An illustrative equation (2) is:

$${Flux}_{steady \text{-} state} = \frac{{P}_{{H}_{2} O}}{( \# dyads ) \cdot ( \frac{{l}_{poly}}{{D}_{poly} {S}_{poly}} + \frac{{l}_{inorg}}{{D}_{inorg} {S}_{inorg}} )}$$

where the subscripts poly and inorg refer to the polymer and inorganic layers.

Values for l, D and S for candidate materials can be derived from the experimental set up or from the open literature. A summary of l, D and S values for individual layers of PET (substrate material), PMMA (decoupling material) at two different layer thicknesses, and AlOₓ (comparative barrier material) is provided in Table 1. Included in Table 1 are experimental (measured) data as well as data reported in the literature.

For the inorganic layers disclosed herein, diffusivity data can be determined experimentally by measuring the degradation of a calcium test patch that is protected by an inorganic thin film.

Calcium patch test samples were prepared using the single-chamber sputter deposition apparatus 200 depicted in FIG. 6. In a first step, calcium shot (Stock #10127; Alfa Aesar) was evaporated through a shadow mask 222 to form calcium dots (0.25 inch diameter, 100 nm thick) on a glass substrate. For calcium evaporation, the chamber pressure was reduced to about 10⁻⁶ Torr. During an initial pre-soak step, power to the evaporation fixtures 280 was controlled at about 20 W for approximately 10 minutes, followed by a deposition step where the power was increased to 80-125 W to deposit about 100 nm thick calcium patterns on each substrate.

Following evaporation of the calcium, the patterned calcium patches were encapsulated using comparative inorganic oxide materials as well as hermetic low melting temperature glass materials according to various embodiments. The glass materials were deposited using room temperature RF sputtering of LMG targets. The LMG targets were prepared in the manner described in commonly-assigned U.S. Pat. Nos. 8,115,326, 5,089,446, 7,615,506, 7,722,929, 7,829,147 and commonly-assigned U.S. Patent Application Publication No. 2007/0040501.

The RF power supply 390 and feedback control 393 (Advanced Energy, Co, USA) were used to form glass layers directly over the calcium having a thickness of about 2-4 micrometers. No post-deposition heat treatment was used. Chamber pressure during RF sputtering was about 1 milliTorr.

In order to evaluate the hermeticity of the glass layer, calcium patch test samples were placed into an oven and subjected to accelerated environmental aging at a fixed temperature and humidity, typically 85° C. and 85% relative humidity (“85/85 testing”). The hermeticity test optically monitors the appearance of the vacuum-deposited calcium layers. As-deposited, each calcium patch has a highly reflective metallic appearance. Upon exposure to water and/or oxygen, the calcium reacts and the reaction product is opaque, white and flaky. Survival of the calcium patch in the 85/85 oven over 1000 hours is equivalent to the encapsulated film surviving 5-10 years of ambient operation. The detection limit of the test is approximately 10⁻⁷ g/m² per day at 60° C. and 90% relative humidity.

A plot of the fraction of reacted calcium versus exposure time to water vapor (85° C., 85% relatively humidity) is shown in FIG. 8, which can be used to calculate the diffusivity D of the inorganic layer according to the relationship τ=L²/6D, where τ is the breakdown time for the calcium patch (determined by extrapolating a fit of the white area versus time curve back to the x-axis) and L is the thickness of the inorganic layer. In the illustrated example, based on a 3 micron thick inorganic layer, the LMG material has a diffusivity of 3.6×10⁻¹⁵ cm²/sec at 85° C. The solubility of the barrier layer material was estimated at 0.021 g/cm³/atm. For comparative purposes, the measured LMG diffusivity at 85° C. was scaled to 38° C. using the appropriate Arhenius expression, yielding an LMG diffusivity at 38° C. corresponding to 1.3×10⁻¹⁶ cm²/sec.

TABLE 1
Diffusivity and Solubility data for PET, PMMA, AlOₓ, and an example
low melting temperature glass.

| | Layer | | | | |
|---|---|---|---|---|---|
| | thickness | Diffusivity [cm²/s] | | Solubility [g/cm³/atm] | |
| Material | [μm] | Measured | Reported | Measured | Reported |
| PET | 177.7 | 8.5 × 10⁻⁹ | 4 × 10⁻⁹ | 0.17 | 0.17 |
| PMMA1 | 0.34 | 8.5 × 10⁻⁹ | 4 × 10⁻⁹ | 0.17 | 0.19 |
| PMMA2 | 0.20 | 8.5 × 10⁻⁹ | 4 × 10⁻⁹ | 0.17 | 0.19 |
| AlOₓ | 0.037 | 1.4 × 10⁻¹³ | ~10⁻³⁰ | 0.029 | — |
| LMG | 0.037 | 1.3 × 10⁻¹⁶ | — | 0.021 | — |

With reference again to Equation 2 and the terms in the parenthesis in the denominator, and by comparing the diffusion and solubility contributions of the disclosed low melting temperature glass materials to the corresponding parameters for any disclosed organic material or comparative inorganic material (see Table 1), we find that the low melting temperature glass materials dominate by about three orders of magnitude if all else is equal. In view of the foregoing, based on the hermetic contribution of the low melting temperature glasses, fewer total dyads (and/or a thinner total laminate) can be used to form an effective hermetic barrier.

From the data in Table 1, a total flux (water vapor transmission rate, or WVTR) can be calculated for a hypothetical (comparative) multilayer as well as for an example multilayer according to one embodiment. As seen with reference to Table 2, the steady-state water vapor transmission rate (Equation 1) for comparative multilayer barrier layers, using conventional inorganic AlOₓ versus LMT material, on 177.7 μm PET substrate is a function of the number of dyad layers in the multilayer. Comparison between multilayer films formed from either AlOₓ or LMT material is based on the single dyad structure, either PMMA2/AlOₓ or PMMA2/LMG formed over a planarized PET substrate (i.e., PMMA1/PET). The planarizing PMM1 layer can reduce the surface roughness of the PET (or other) substrate. Successive dyads can be provided over the substrate as (PMMA2/AlOₓ)ₙ/PMMA1/PET or (PMMA2/LMG)ₙ/PMMA1/PET to form the multilayer laminate. For the PMMA2 layers, the effective path length L=100 μm was substituted in place of the physical film thickness. In addition, D_{PET}=D_{PMMA1}=D_{PMMA2}=8.5·10⁻⁹ cm²/s, S_{PET}=S_{PMMA1}=S_{PMMA2}=0.17 g/cm³/atm, D_{AlOx}=1.4·10⁻¹³ cm²/s, S_{AlOx}=0.02 g/cm³/atm and the vapor pressure of water (P_{H2O})=0.06 atm at 38° C.

TABLE 2
WVTR data for comparative AlOₓ-based and LMG-based multilayers.

| | WVTR | WVTR |
|---|---|---|
| # Dyad | (PMMA2/AlOₓ)ₙ/PMMA1/ | (PMMA2/LMG)ₙ/PMMA1/PET |
| Layers, n | PET [g/m²/day] | [g/m²/day] |
| 0 | 4.2 | 4.2 |
| 1 | 0.0387 | 0.00003648 |
| 2 | 0.0194 | 0.00001821 |
| 3 | 0.0130 | 0.00001214 |
| 4 | 0.0097 | 0.00000911 |
| 5 | 0.0078 | 0.00000729 |

With reference to Table 2, it can be seen that by substituting a low melting temperature glass material for the alumina layer in a multi-layer laminate, a substantial improvement in the hermeticity can be achieved for a given number of dyad layers.

The diffusivity and solubility coefficients of the inorganic layers disclosed herein can be orders of magnitude less than the values that can be achieved using organic material-based seals. Devices that are sealed using the disclosed materials and methods can exhibit water vapor transmission (WVTR) conditions less than 10⁻⁶ g/m²/day, which enables long-life operation.

A hermetic layer is a layer which, for practical purposes, is considered substantially airtight and substantially impervious to moisture. By way of example, the hermetic barrier layer can be configured to limit the transpiration (diffusion) of oxygen through the barrier to less than about 10⁻² cm³/m²/day (e.g., less than about 10⁻³ cm³/m²/day), and limit the transpiration (diffusion) of water through the barrier to about 10⁻² g/m²/day (e.g., less than about 10⁻³, 10⁻⁴, 10⁻⁵ or 10⁻⁶ g/m²/day). In embodiments, one or more dyad layers substantially inhibit air and water from contacting an underlying substrate.

As used herein, the singular forms “a,” “an” and “the” include plural referents unless the context clearly dictates otherwise. Thus, for example, reference to a “layer” includes examples having two or more such “layers” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a glass substrate that comprises a glass material include embodiments where a glass substrate consists of a glass material and embodiments where a glass substrate consists essentially of a glass material.

It will be apparent to those skilled in the art that various modifications and variations can be made to the present disclosure without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A protected substrate comprising:
a dyad layer including a barrier layer and a decoupling layer formed over a major surface of a substrate, wherein the barrier layer comprises a glass material selected from the group consisting of a tin fluorophosphate glass, a tungsten-doped tin fluorophosphate glass, a chalcogenide glass, a tellurite glass, a borate glass and a phosphate glass and the decoupling layer comprises a polymer layer.

2. The protected substrate according to claim 1, wherein from 2 to 6 dyad layers are formed over the substrate.

3. The protected substrate according to claim 2, wherein each decoupling layer is in physical contact with a pair of opposing barrier layers.

4. The protected substrate according to claim 1, wherein the barrier layer is in physical contact with the substrate.

5. The protected substrate according to claim 2, wherein a barrier layer is in physical contact with the substrate and each decoupling layer is in physical contact with a pair of opposing barrier layers.

6. The protected substrate according to claim 1, wherein the decoupling layer is in physical contact with the substrate.

7. The protected substrate according to claim 1, wherein the barrier layer comprises a glass material including:
20-75 wt. % Sn,
2-20 wt. % P,
10-36 wt. % O,
10-36 wt. % F, and
0-5 wt. % Nb.

8. The protected substrate according to claim 1, wherein the barrier layer comprises a glass material including:
55-75 wt. % Sn,
4-14 wt. % P,
6-24 wt. % O,
4-22 wt. % F, and
0.15-15 wt. % W.

9. The protected substrate according to claim 1, wherein the barrier layer comprises a glass material having a glass transition temperature of less than 400° C.

10. The protected substrate according to claim 1, wherein the barrier layer comprises a glass material having a softening point of less than 500° C.

11. The protected substrate according to claim 1, wherein the barrier layer has an average thickness of from about 10 nm to 50 microns.

12. The protected substrate according to claim 1, wherein the decoupling layer comprises a polymer selected from the group consisting of poly(methyl methacrylate), polyethylene naphthalate, polyethersulfone, polycarbonate, polyethylene terephthalate, polypropylene and oriented polypropylene.

13. The protected substrate according to claim 1, wherein the decoupling layer has an average thickness of from about 200 nm to 50 microns.

14. The protected substrate according to claim 1, wherein the dyad layer is optically translucent.

15. The protected substrate according to claim 1, wherein the dyad layer is optically transparent.

16. The protected substrate according to claim 1, wherein the substrate comprises a flexible substrate.

17. The protected substrate according to claim 1, wherein the substrate comprises a glass plate infiltrated with phosphor.

18. The protected substrate according to claim 1, wherein the substrate comprises gallium nitride.

19. The protected substrate according to claim 1, wherein the major surface of the substrate has an arithmetic roughness of less than 100 nm.

20. A method for forming a protected substrate comprising:
providing a dyad layer including a barrier layer and a decoupling layer over a major surface of a substrate, wherein the barrier layer comprises a glass material selected from the group consisting of a tin fluorophosphate glass, a tungsten-doped tin fluorophosphate glass, a chalcogenide glass, a tellurite glass, a borate glass and a phosphate glass and the decoupling layer comprises a polymer layer.

21. The method according to claim 20, wherein the barrier layer is formed in physical contact with the major surface of the substrate and the decoupling layer is formed in physical contact with the barrier layer.

22. The method according to claim 20, wherein the barrier layer is first formed in physical contact with the decoupling layer to form the dyad layer and the dyad layer is provided in physical contact with the substrate.

23. The method according to claim 22, wherein the dyad layer is arranged such that the barrier layer is in physical contact with the substrate.
